(19) United States
(12) Patent Application Publication
(10) Pub. No.: US 2005/0091394 A1
(43) Pub. Date: Apr. 28, 2005

(54) Software configurable dual cable redundant Ethernet or bus configuration

(75) Inventors: Richard H. Breinlinger, Hampstead, NH (US); Merrill W. Harriman, Nashua, NH (US)

Correspondence Address: Larry I. Golden;Square D Company, 1415 South Roselle Road, Palatine, IL, 60067, US

(73) Assignee: Schneider Automation Inc.

(21) Appl. No.: 10/694,462

(22) Filed: Oct. 27, 2003

(51) Int. Cl. G06F 15/16

(52) U.S. Cl. 709/231

(57) ABSTRACT

A system having a redundant topology for communication between one or more devices and a central hub. The system comprises a central hub or switch and one or more end nodes where each end node includes a first port and a second port. A first active cable is connected to the first port in each end node and a first port in the hub and, a second active cable is connected to the second port in each end node and a second port in the hub. Messages are transmitted across both the first and second cables to the first and second ports of the end nodes. The end node performs an integrity check on the messages received over the first and second cables and utilizes the first one to pass the check. Thus, if one cable malfunctions, the end node still is able to receive the message over the other cable without any loss of data.

### TECHNICAL FIELD

The present invention is generally related to redundant data communication between network nodes, and more particularly to a system utilizing dual cables for transmitting messages to a plurality of devices for enhancing the reliability of communication.

### BACKGROUND

Many automated installations are networked to allow for communication with and between the various components and/or devices of the installation. A variety of schemes or topologies are typically used to connect each component or device to the network. For example, the devices may be connected in a star configuration to one or more hubs or switches. Alternative topologies include a daisy chain configuration having a plurality of devices chained together. The daisy chain configuration can have multiple chains connected to a hub or switch. Another alternative is to connect each device to a main bus. Another common configuration is a ring topology.

Various software and hardware implementations are utilized to assure that communication with the networked components is accurate and reliable. However, if a cable connecting a particular device to a network malfunctions (e.g., disconnected, cut, noise etc.) it is not possible to communicate with that device (or any downstream devices chained to that device).

One company, Metrobility (see www.metrobility.com), provides a dual cable Ethernet system. This system utilizes two cables to connect components in the system. However, only one cable is active at any given time. That is, one of the cables is the primary active cable that transmits messages in the system, and the other cable is an inactive spare. The inactive spare cable is only switched into active service if a problem is detected on the primary active cable. Accordingly, when the primary active cable experiences a problem, data in route to another node in that cable is lost, as well as all other transmitted data for some period of time until the system detects the problem and switches to the spare cable. This loss of data may be critical to the functioning of the system.

The present invention provides a reliable system that enables communication to continue even in the event of a malfunction in a cable.

### SUMMARY OF THE INVENTION

The present invention is directed to a system that utilizes two or more cables to provide a redundant communication system to a plurality of devices or end nodes. Each of the cables is active all of the time. The redundant system enhances the reliability of the data communication without risk of lost data.

In some installations, it is desirable to enhance reliability by utilizing a redundant (e.g., 2×, 3× or more) cabling system for communications between network nodes. The networks can utilize a number of different configurations or topologies. In certain applications it is desirable to have a daisy chain configuration of the cabling. In others a conventional star topology of 10T or 100T Ethernet cabling schemes is utilized, or a ring topology. The present invention can enhance all of these choices by allowing a single module to be configured for any of these cabling schemes or for the conventional star wiring.

In contrast to other systems, the present invention provides a system utilizing two or more active cable connections to each of the nodes in the system. In normal operation a receiving node receives two (or more) identical packets (e.g., messages) from the two (or more) cables. The packet that arrives first and passes an integrity check (e.g., a CRC check) is used by the node. The second packet is discarded. If a cable breaks (or otherwise malfunctions) in the middle of a packet, that received packet will not pass the integrity check and will be discarded; however, the packet from the other cable will arrive, pass the integrity check and be used by the node with no loss of data.

Additionally, each of the cables can be strategically routed to avoid loss due to noise in the system. Specifically, the two cables (in a dual redundant cable system) are installed with different routing. In this manner, each may be subjected to different levels of electrical noise. If one of the cables is subjected to sufficient electrical noise that it malfunctions, the other cable, having a different routing (and therefore not subject to the same noise as the first cable), may be able to pass the packet without loss. The system, by taking the first signal to arrive which has a valid integrity check, automatically selects the signal which was not distorted by noise and uses it without slowing the system down by waiting for a time out due to lack of acknowledgement to a valid packet.

In one embodiment of the invention, a system having a redundant topology for communication between one or more devices and a central hub comprises a central hub or switch, and at least a first end node having a first port and a second port. The ports are Ethernet ports. A first cable is connected to the first port in the end node and a first port in the hub; and, a second cable is connected to the second port in the end node and a second port in the hub. Both the first cable and the second cable are active. Accordingly, in operation, a message is transmitted by the hub or switch to the first end node over both the first cable to the first port and over the second cable to the second port. In this manner, reliability is enhanced because the message would still be transmitted to the end node even if one of the cables malfunctioned.

The system can include a second end node having a first port and a second port. A third cable is connected to the first port in the second end node and a third port in the hub; and, a fourth cable is connected to the second port in the second end node and a fourth port in the hub. Preferably, the system includes a plurality of additional end nodes, wherein each end node has a first port and a second port, and, a plurality of additional cables, each cable connecting one of the first port and the second port of one of the plurality of additional end nodes to a corresponding port in the hub. Again, a message between any of the end nodes and the hub is carried by both cables connected to each node.

The hub or switch can be connected to an Internet or an Intranet. Thus, messages can be transmitted to and from the end nodes through the hub to the Internet or an Intranet.

The system can be configured a star configuration with each end node having two cable connections to the hub. The end nodes could be devices, such as for example, a programmable logic controller (PLC); IO module; bridge; gateway; relay; or motor starter.

In another embodiment of the invention an end node for use in a system having a redundant topology comprises a device having a first upstream connection port for upstream connection to one of a another device and a hub, a second upstream connection port for upstream connection to the one of a another device and a hub, a first downstream connection port for downstream connection to another device, and a second downstream connection port for downstream connection to another device. Additional upstream and downstream connection ports can be provided for further redundancy. The end node passes packets of data (e.g., messages) between the first upstream port and the first downstream port, and between the second upstream port and the second downstream port.

In yet another embodiment of the invention, a system having a redundant daisy chained configuration comprises a central hub; and, a first chain of end nodes. The first chain of end nodes includes a first end node having a first upstream port, a second upstream port, a first downstream port and a second downstream port, a first active cable connecting the first port of the first end node to the hub, a second active cable connecting the second upstream port to the hub, a third active cable connecting the first downstream port to a first upstream port of a second end node in the first chain, and a fourth active cable connecting the second downstream port to a second upstream port of the second end node. The second node can also include a first downstream port and a second downstream port. A fifth active cable can connect the first downstream port of the second node to a first upstream port of a third end node in the first chain, and a sixth active cable can connect the second downstream port of the second end node in the first chain to a second upstream port in the third end node in the first chain. This can be repeated to include an indefinite number of nodes. Moreover, more than two active cables can be employed between the nodes (in this embodiment, the nodes must be provided with additional ports). In this manner, a plurality of nodes could be configured in the chain with the redundant cabling system.

The system can comprise a one or more additional chains of end nodes also having a plurality of devices configured for two or more redundant cable connections.

In yet another embodiment of the invention, a redundant network system comprises a bus connecting a plurality of end nodes wherein each end node includes a first port connected to the bus by a first active cable for receiving and sending messages, and a second a port connected to the bus by a second active cable for receiving and sending messages. Similar to the other embodiments, the same message is transmitted or received over both the first and second cables connected to each end node. The first message that passes an integrity check is used. The bus can be connected to a hub, which in turn, can be connected to an Internet or Intranet. One or more of the devices connected to the bus may have further devices connected in a chain as described above.

In yet a further embodiment of the invention, an end node for use in a redundant network system comprises a device having a first port for connecting to the system to receive a first message over a first active cable, and a second port for connecting to the system to receive the first message (i.e., the same message as that transmitted over the first active cable) over a second active cable. The end node is configured to employ an integrity check on the first message received over both the first active cable and the second active cable and utilize the message that arrived first which passes the check.

In the systems described, the first cable between two nodes, or the hub and a node, can be provided (i.e., installed in the facility) with a first route, and a second cable between the two nodes, or the hub and the node, can be provided with a second route wherein the first route is different from the second route. A “route” is the physical path traveled by a cable through the system from one component to another. If more than two cables are utilized in the system, the additional cables may be provided with yet further routes that differ from the first two routes and (possibly) from each other.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic drawing of a plurality of devices connected in a typical star configuration;

FIG. 2 is a schematic drawing of a plurality of devices connected in a daisy chained configuration.

FIG. 3 is a schematic drawing of a redundant star configuration in accordance with one aspect of the present invention; and,

FIG. 4 is a schematic drawing of a redundant daisy chained configuration in accordance with another embodiment of the invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

In automated plants, it is necessary to have efficient and accurate communication between the various devices and controllers. A number of networking schemes and systems have been employed to provide such communication.

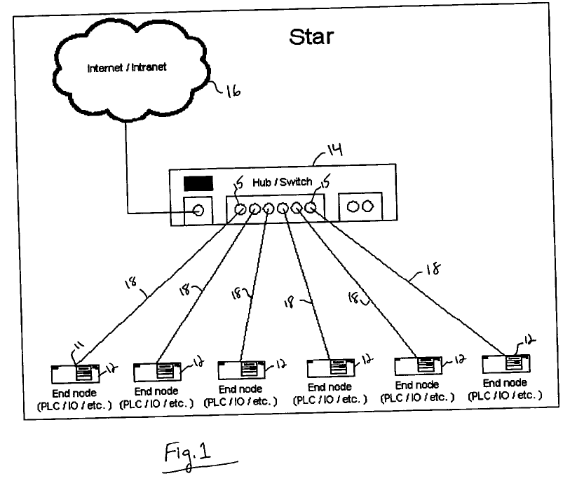

Prior to the present invention, it was well known to connect a plurality of devices or nodes in a number of different topologies or configurations. For example, FIG. 1 shows a plurality of devices, referred to as end nodes 12, connected to a hub or switch 14 in a star configuration. The hub or switch 14 can be connected, in turn, to an Internet or Intranet 16. The end nodes 12 may be, for example, programmable logic controllers (PLCs), IO modules or devices, bridges, gateways, motor starters, relays, or other similar devices. As illustrated in FIG. 1, each individual node 12 is provided with a single Ethernet port 11, and has a single cable connection 18 directly back to the hub or switch 14.

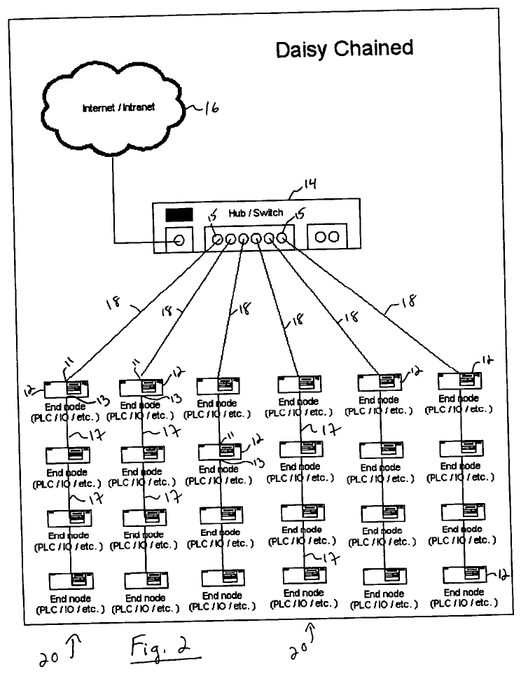

Another known configuration is a daisy chained topology as shown in FIG. 2. In this configuration, each end node 12 has two Ethernet ports 11 and 13. A first port 11 is connected upstream by a single cable 17 toward a hub or switch 14, and the second port 13 is connected downstream via another single cable 17 toward the next device 12 in a chain 20 (the last node has an unused port or may only include one port). FIG. 2 shows six chains 20 of end nodes 12, where the first end node 12 in each chain is connected by a cable 18 to a position (i.e., port) 5 in the hub or switch 14.

Each of the end nodes 12 shown in FIG. 2 may perform a message forwarding function by software or hardware. If the message forwarding is accomplished by hardware, the end node 12 may have an internal Ethernet switch with store-and-forward technology or with cut-through technology. In the store-and-forward approach, a message is stored in memory inside the end node 12 and is then forwarded to the next end node 12 in the chain 20. Cut through technology allows the end node 12 to pass the message to the next device without storing the message. Accordingly, there is little, if any, delay in receiving the message by the end node 12 addressed.

The daisy chained configuration provides the benefit of reduced cabling cost as each chain 20 only needs a single cable 18 back to the hub or switch 14 from the chain 20 of end nodes 12, rather than a cable for each end node 12 in the chain 20. Additionally, a fewer number of hubs or switches 14 are needed for a particular installation in a plant, and placements of the hubs or switches 14 throughout the plant are not as critical because there can be fewer long Ethernet cables required.

The prior star and daisy chained configurations were susceptible to malfunction if a problem occurred with a cable connection 17 or 18 between the end nodes 12 and/or hub or switch 14. In such an event, the end node 12 (and any subsequent end nodes 12 chained to the end node where the malfunction occurred) would not be able to receive messages from or send messages to the hub or switch 14.

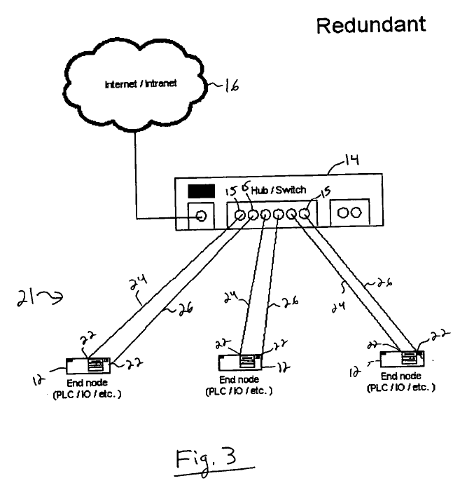

A redundant topology or system 21 in accordance with the present invention is shown in a star configuration as illustrated in FIG. 3. In the embodiment shown in FIG. 3, each device or end node 12 has two or more Ethernet ports 22. Unlike prior topologies, the additional ports 22 are used to provide two or more connections between the hub or switch 14 and the end node 12. As shown in FIG. 3, each end node 12 includes a first cable connection 24 and a second cable connection 26 to the hub or switch 14. Each end node is connected to two positions 15 in the hub or switch 14.

The messages to and from each end node 12 to the hub or switch 14 are carried across both cables 24, 26. In this regard, both cable 24, 26 are always “active.” However, each end node 12 should be able to operate with only one of the two (or more) cables 24, 26. The redundant connection(s) protects against one of the connections 24 or 26 becoming inoperable. This may occur, for example, if one of the cables 24 or 26 becomes disconnected either at the hub or switch 14 or at the end node 12, or is cut etc. Additionally, electrical noise may corrupt a message on a cable thus rendering it useless.

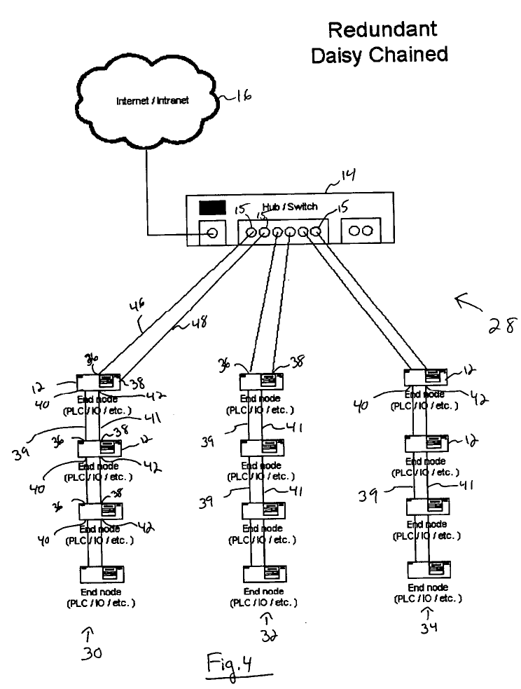

The redundant topology is shown in a daisy chained configuration or system 28 as illustrated in FIG. 4. The system 28 includes a first chain 30 of devices 12 connected to the hub 14, a second chain 32 of devices 12 and a third chain 34 of devices 12. However, the number of chains can vary from the three shown as required by the needs of the system and the number of devices being networked.

In the embodiment shown in FIG. 4, each of the end nodes 12 include four Ethernet ports. Two of the four ports, a first port 36 and a second port 38, are used to connect an end node 12 upstream (i.e., toward the hub or switch 14) via a first active cable 39 and a second active cable 41 to the next end node 12 in a chain 30, 32 or 34. Each end node 12 is connected to the next upstream end node 12 until the first end node 12 in the chain is reached. The first end node 12 in the chain utilizes the first port 36 and the second port 38 to connect the chain via a first active cable 46 and a second active cable 48, respectively, to two positions 15 in the hub or switch 14. Each of the end nodes 12 includes a second set of two ports, a third port 40 and a fourth port 42, to connect the end node 12 downstream (i.e., away from the hub or switch 14) to the upstream ports 36 and 38 of the next end node 12 in the chain 30, 32 or 34.

This configuration provides the benefits of a redundant system (i.e., more reliable in the event of one cable malfunctioning), with that of a daisy chained topology (i.e., less cost than individually connecting each device to a hub or switch). As in the other embodiments, the same message is transmitted over both cables 39 and 41 connecting each of the end nodes 12 and the hub 14. The end nodes 12 include software that allows the end nodes 12 to utilize the message received from the first cable 39 or the message received from the second cable 41. This includes passing the message either upstream or downstream over both the first cable 39 and the second cable 41 to the next end node 12 or hub 14. Thus, if a single cable between any of the end nodes 12 or hub 14 malfunctions, the message is still received by the end node 12 or hub 14 and can be further transmitted.

When a packet of data (e.g., a message) is received by an end node 12 in the system over a first cable, a CRC integrity check is done on the packet to verify that there are no errors in the data. A CRC integrity check is also done to the packet received by the end node 12 over the second cable. The end node 12 uses the first packet that passes the integrity check, and discards (i.e., ignores) the other message.

The cables are shown schematically in the drawings as straight lines connecting the hub or switch and the nodes. However, in practice, cables connecting various components are not routed in a straight line. In fact, the cables can typically be routed through a facility along a large variety of paths. To enhance the reliability of a system using two (or more) active cables carrying the same packets, each cable is provided with a different route. That is, for an end node 12 connected to a first cable and a second cable to another node or the hub or switch, the first cable can have a first route and the second cable can have a second route different than the first route. Additional cables can have corresponding routes different from the first and second routes, and from each other. Because each cable has a different route, it may be subjected to a different level of electrical noise than the other cable(s). Accordingly, if one cable experiences sufficient electrical noise to cause a malfunction, the other cable may transmit the packet without error. If both cables had the same route, noise effecting one cable would likely effect the other and thus negate one advantage in having a dual cable system (however, such a system would still be advantageous for other types of malfunctions).

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A system having a redundant topology for communication between one or more devices and a central hub comprising:
a central hub having a plurality of ports;
a first end node having a first port and a second port;
a first active cable connected to the first port in the end node and a first port of the plurality of ports in the hub; and,
a second active cable connected to the second port in the end node and a second port of the plurality of ports in the hub, wherein the first active cable and the second active cable transmit a same first packet of data to the first end node.

2. The system of claim 1 further comprising:
a second end node having a first port and a second port;
a third active cable connected to the first port in the second end node and a third port in the hub; and,
a fourth active cable connected to the second port in the second end node and a fourth port in the hub, wherein the third active cable and the fourth active cable transmit a same second packet of data to the second end node.

3. The system of claim 1 further comprising:
a plurality of additional end nodes, each end node having a first port and a second port, and,
a plurality of additional active cables, each active cable connecting one of the first port and the second port of one of the plurality of additional end nodes to a corresponding port of the plurality of ports in the hub.

4. The system of claim 1 wherein the first end node is configured to perform an integrity check to a packet of data received on the first active cable and is configured to perform an integrity check on a packet of data received on the second active cable.

5. The system of claim 4 wherein the integrity check to a packet of data received on the first active cable is a CRC check, and wherein the integrity check to a packet of data received on the second active cable is a CRC check.

6. The system of claim 1 wherein the first active cable is provided a first route from the first end node to the hub, and the second active cable is provided a second route from the first end node to the hub, and wherein the first route is different than the second route.

7. The system of claim 3 wherein each active cable connecting a specific one of the plurality of end nodes to the hub is provided with a different route from the specific one of the plurality of end nodes to the hub.

8. The system of claim 1 wherein the hub is connected to an Internet.

9. The system of claim 1 wherein the hub is connected to an Intranet.

10. The system of claim 3 wherein the hub is connected to an Internet.

11. The system of claim 3 wherein the hub is connected to an Intranet.

12. The system of claim 3 wherein the first end node and the plurality of end nodes are configured in a star configuration with each end node having two cable connections to the hub.

13. The system of claim 3 wherein in one of the first end node and the plurality of end nodes is a programmable logic controller.

14. The system of claim 3 wherein in one of the first end node and the plurality of end nodes is an IO device.

15. The system of claim 3 wherein in one of the first end node and the plurality of end nodes is a bridge.

16. The system of claim 3 wherein in one of the first end node and the plurality of end nodes is a gateway.

17. The system of claim 3 wherein in one of the first end node and the plurality of end nodes is a relay.

18. The system of claim 3 wherein in one of the first end node and the plurality of end nodes is a motor starter.

19. The system of claim 1 wherein the end node utilizes one of the packet of data received from the first active cable and the packet of data received from the second active cable that is first determined by the end node to be valid.

20. The system of claim 4 wherein the end node only performs an integrity check on a second one of the packet received from the first active cable and the packet received by the second active cable if an integrity check on a first one of the packet received from the first active cable and the packet received of the second active cable fails.

21. An end node for use in a system having a redundant topology comprising:
a device having a first upstream connection port for upstream connection via an active first cable to one of a another device and a hub, a second upstream connection port for upstream connection via a second active cable to the one of a another device and a hub, a first downstream connection port for downstream connection via a third active cable to another device, and a second downstream connection port for downstream connection via a fourth active cable to another device.

22. The end node of claim 21 further comprising:
a third upstream connection port for upstream for upstream connection via a fifth active cable to one of a another device and a hub.

23. The end node of claim 21 further comprising:
a third downstream connection port for downstream connection via a sixth active cable to a another device.

24. The end node of claim 21 further comprising:
a plurality of additional upstream connection ports, each of the plurality of additional upstream connections ports for upstream connection via a corresponding first plurality of additional active cables to one of a another device and a hub.

25. The end node of claim 24 further comprising:
a plurality of additional downstream connection ports, each of the plurality of downstream connection ports for downstream connection via a corresponding second plurality of additional active cables to another device.

26. The end node of claim 21 wherein each of the ports is an Ethernet port.

27. The end node of claim 21 wherein the device is a programmable logic controller.

28. The end node of claim 21 wherein the device is a bridge.

29. The end node of claim 21 wherein the device is a gateway.

30. The end node of claim 21 wherein the device is a relay.

31. The end node of claim 21 wherein the device is a motor starter.

32. The end node of claim 21 wherein the device is an IO module.

33. A system having a redundant daisy chained configuration comprising:
a central hub; and,
a first chain of end nodes including a first end node having a first upstream port, a second upstream port, a first downstream port and a second downstream port, a first active cable connecting the first port of the first end node to the hub, a second active cable connecting the second upstream port to the hub, a third active cable connecting the first downstream port to a first upstream port of a second end node in the first chain, and a fourth active cable connecting the second downstream port to a second upstream port of the second end node.

34. The system of claim 33 wherein each end node in the first chain utilizes a first valid message received by the end node over any of the active cables connected to the end node.

35. The system of claim 33 wherein the second node of the first chain includes a first downstream port and a second downstream port.

36. The system of claim 35 further comprising a fifth active cable connecting the first downstream port of the second node to a first upstream port of a third end node in the first chain, and a sixth active cable connecting the second downstream port of the second end node in the first chain to a second upstream port in the third end node in the first chain.

37. The system of claim 33 further comprising a second chain of end nodes, the second chain of end nodes including a first end node having a first upstream port, a second upstream port, a first downstream port and a second downstream port, a first active cable connecting the first port of the first end node to the hub, a second active cable connecting the second upstream port to the hub, a third active cable connecting the first downstream port to a first upstream port of a second end node in the second chain, and a fourth active cable connecting the second downstream port to a second upstream port of the second end node.

38. The system of claim 37 further comprising a fifth active cable connecting the first downstream port of the second node in the second chain to a first upstream port of a third end node in the second chain, and a sixth active cable connecting the second downstream port of the second end node in the second chain to a second upstream port in the third end node in the second chain.

39. The system of claim 33 further comprising a plurality of chains of end nodes connected to the hub, wherein each of said plurality of chains include a first end node having a first upstream port, a second upstream port, a first downstream port and a second downstream port, a first active cable connecting the first port of the first end node to the hub, a second active cable connecting the second upstream port to the hub, a third active cable connecting the first downstream port to a first upstream port of a second end node in each chain, and a fourth active cable connecting the second downstream port to a second upstream port of the second end node in each chain.

40. The system of claim 39 wherein at least one of the end nodes in the plurality of chains of end nodes is a programmable logic controller.

41. The system of claim 39 wherein at least one of the end nodes in the plurality of chains of end nodes is an IO module.

42. The system of claim 39 wherein at least one of the end nodes in the plurality of chains of end nodes is a bridge.

43. The system of claim 39 wherein at least one of the end nodes in the plurality of chains of end nodes is a gateway.

44. The system of claim 39 wherein at least one of the end nodes in the plurality of chains of end nodes is a motor starter.

45. The system of claim 39 wherein at least one of the end nodes in the plurality of chains of end nodes is a relay.

46. An end node for use in a redundant network system comprising a device having a first port for connecting to the system to receive a first message over a first active cable, and a second port for connecting to the system to receive the first message over a second active cable wherein the device is configured to utilize one of the first message received over the first active cable and the first message received over the second active cable that first passes an integrity check performed by the device.

47. The end node of claim 46 wherein the first port is an Ethernet port and the second port is an Ethernet port.

48. The end node of claim 46 wherein the device can transmit a second message over the first active cable through the first port, and transmit the second message over the second active cable through the second port.

49. The end node of claim 46 wherein the device is a programmable logic controller.

50. The end node of claim 46 wherein the device is an IO module.

52. The end node of claim 46 wherein the device is a bridge.

53. The end node of claim 46 wherein the device is a gateway.

54. The end node of claim 46 wherein the device is a motor starter.

55. The end node of claim 46 wherein the device is a relay.
